(19) United States
(12) Patent Application Publication
(10) Pub. No.: US 2006/0191488 A1
(43) Pub. Date: Aug. 31, 2006

(54) P-Pole

(76) Inventor: Stephen Ricchiuti, Stow, OH (US)

Correspondence Address: LINDON & LINDON, 1250 LINDA STREET, ROCKY RIVER, OH, 44116, US

(21) Appl. No.: 11/293,732

(22) Filed: Dec. 5, 2005

Related U.S. Application Data
(60) Provisional application No. 60/657,135, filed on Feb. 28, 2005.

(51) Int. Cl. A01K 29/00

(52) U.S. Cl. 119/161; 119/165

(57) ABSTRACT

A device for waste relief by an animal. The device includes a generally vertical pole portion and a generally horizontal tray portion operatively connected to the pole portion. The device includes a generally vertical screen portion operatively connected to the tray portion and an absorbent material operatively connected to the pole portion. A portion of the absorbent material is positioned generally vertically along the pole portion.

### BACKGROUND OF THE INVENTION

Having an indoor pet presents a number of problems. One such problem is the pet's need to relieve waste products, such as urine. Having a pet urinate on indoor furniture or unprotected indoor floor surfaces is clearly undesirable. One possible solution is to provide a means for the pet to selectively leave the house. When that solution is not preferred, other alternatives may be desired.

Liter boxes are a possible solution, though current embodiments have been largely unsuccessful in providing pet owners with a satisfactory solution. There remains a long-felt need for a means of allowing a pet to relieve waste products, particularly when the pet is indoors.

### BRIEF DESCRIPTION OF THE DRAWINGS

FIG. 1 is a top plan view of a P-Pole in accordance with the present invention.

FIG. 2 is a side elevational view of the P-Pole of FIG. 1.

FIG. 3 is a side elevational view of the P-Pole of FIG. 1 viewed generally along line 3-3.

FIG. 4 is a side elevational view of the P-Pole of FIG. 1 viewed generally along line 4-4.

FIG. 5 is a side elevational view of the P-Pole of FIG. 1 viewed generally along line 5-5.

FIG. 6 is a side elevational view of the P-Pole of FIG. 1 with a vertical extension.

FIG. 7 is a side elevational view of the P-Pole of FIG. 6 with an absorbent material.

FIG. 8 is a side elevational view of the P-Pole of FIG. 1 with a screen portion.

FIG. 9 is a side elevational view of the screen portion viewed generally along line 9-9.

FIG. 10 is a top plan view of the screen portion viewed generally along line 10-10.

### DETAILED DESCRIPTION OF THE INVENTION

This application claims the benefit of U.S. Provisional Application No. 60/657,135 filed 2-28-2005.

Preliminarily, it should be noted that certain terms used herein, such as for example above, below, upper, lower left and right, are used to facilitate the description of the invention. Unless otherwise specified or made apparent by the context of the discussion, such terms and other directional terms should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first”, and “second” are not intended as a limitation or to imply a sequence, unless otherwise specified or made apparent by the context of the discussion. The term “operatively connected” is understood to include [but is not limited to] a linking together of the portions under consideration and may include a physical engagement and/or a functional or operational connection.

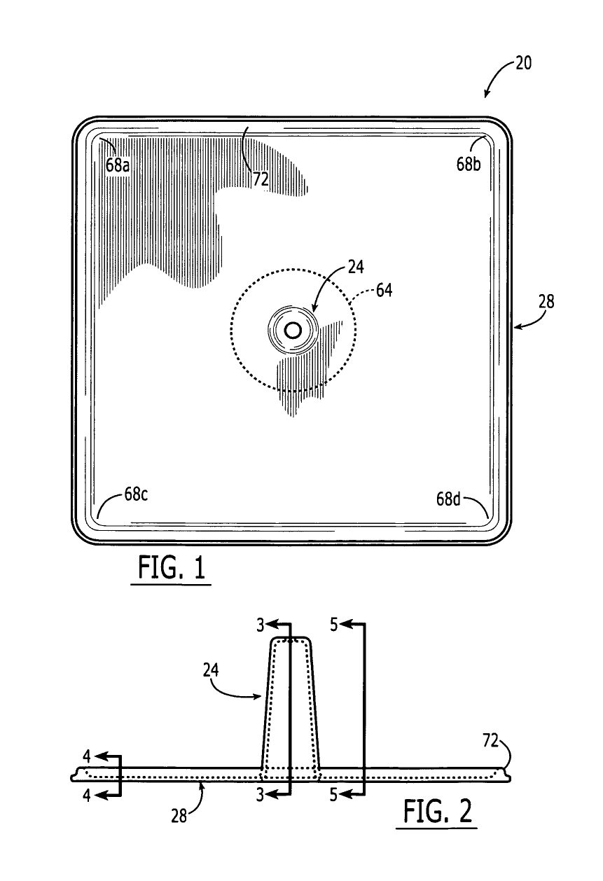

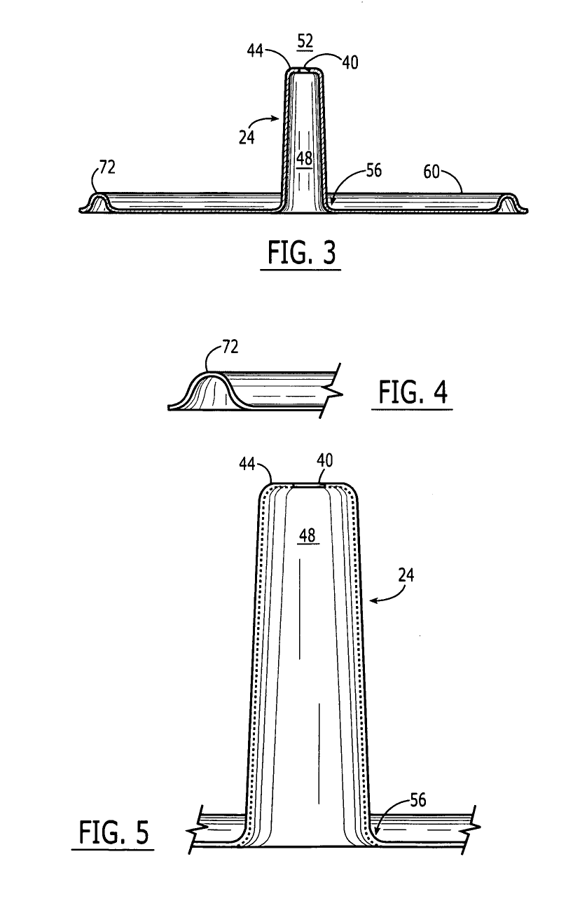

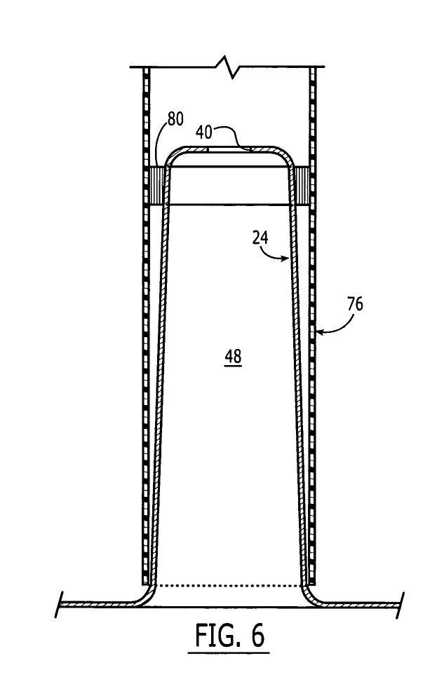

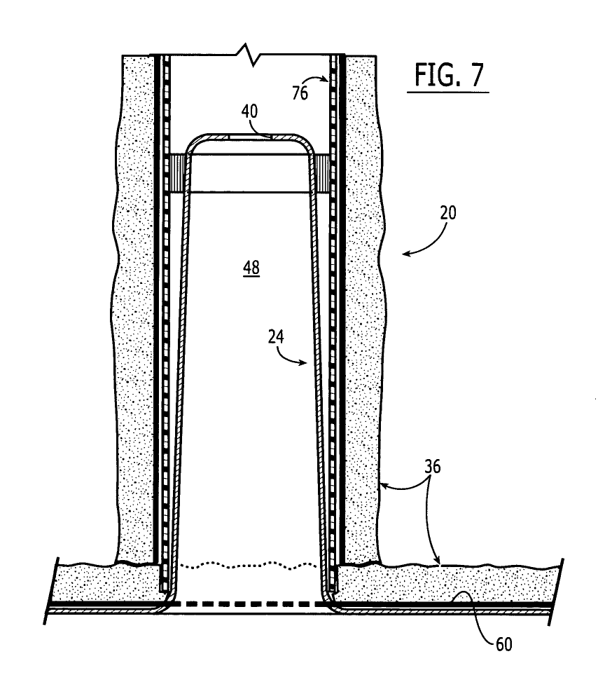

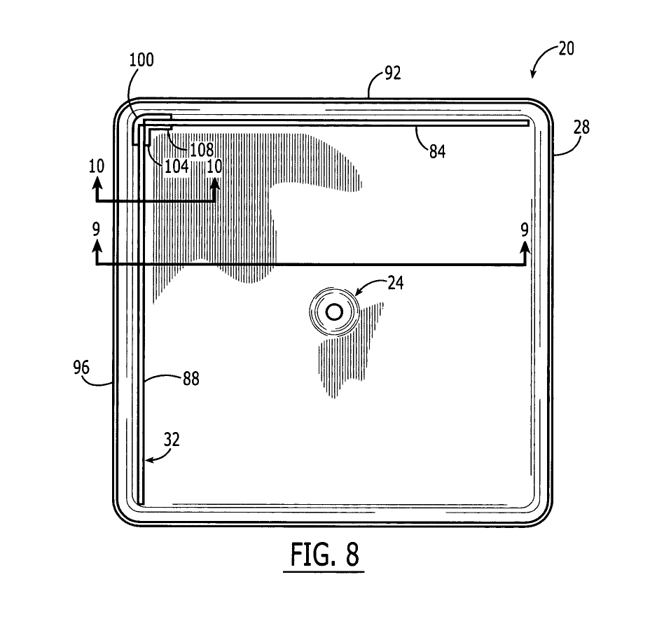

Referring now to the drawings there is illustrated in FIGS. 1 through 10 a P-Pole indicated generally at 20, according to the invention. The illustrated P-Pole 20 is a device for waste relief by an animal—such as, for example, a dog. The illustrated P-Pole 20 includes a tray portion 28 and a pole portion 24. The illustrated P-Pole 20 also includes a screen portion 32. The illustrated P-Pole 20 also includes an absorbent material 36.

The pole portion 24 and the tray portion 28 are operatively connected. The illustrated pole portion 24 is generally conical, but does not have to be. The term “conical” may be understood to include [but is not limited to] any structure or functionality which has a generally circular base at one end and tapers to a point at the other end. A “conical” geometric figure may be formed by generally straight lines through a generally fixed point vertex to the point(s) of a generally fixed curve directrix. The pole portion 24 may have any suitable shape and/or profile.

The illustrated pole portion 24 includes an opening 40 located generally at the upper part 44 of the pole portion 24, but does not have to. The opening 40 allows for fluid communication between the inner space 48 of the pole portion 24 and the outer space 52 of the pole portion 24. The illustrated opening 40 is generally rounded, but does not have to be. The upper part 44 of the pole portion 24 is shown generally narrower than the lower part 56 of the pole portion 24, but does not have to be.

The pole portion 24 may be coupled with a base portion 60 at the lower part 56 of the pole portion 24. The base portion 60 is shown generally flat and generally squared with rounded corners 68a, 68b, 68c, 68d—but may be any suitable shape. The pole portion 24 is positioned in a generally central region 64 of the base portion 60. A ridge 72 may be provided around the periphery of the base portion 60 of the P-Pole 20. The ridge 72 may be a generally rounded and generally raised lip.

The pole portion 24 may be coupled with an extension 76. The illustrated extension 76 is generally vertical and generally tubular, but does not have to be. When the extension 76 is employed, a spacer 80 may be used. The spacer 80 may be positioned between the inner diameter of the tubular extension 76 and the pole portion 24 of the P-Pole 20. The illustrated spacer 80 is generally annular, or ring shaped, but does not have to be. The spacer 80 is shown positioned at the upper part 44 of the pole portion 24, but may be positioned as desired.

The tray portion 28 and the screen portion 32 are operatively connected. The pole portion 24 is positioned in a generally central region of the tray portion 28 of the P-Pole 20. The screen portion 32 may be generally vertical as shown. The screen portion 32 is positioned at a peripheral region of the tray portion 28. The tray portion 28 may be a four-sided structure, or any other suitable shape.

The illustrated screen portion 32 is generally flat, but does not have to be. The screen portion 32 optionally includes a first panel 84 and a second panel 88. The first panel 84 and the second panel 88 are shown positioned generally perpendicular to each other. The first panel 84 and the second panel 88 are shown as generally flat plates, but don't have to be. The first panel 84 and the second panel 88 are shown positioned generally adjacent to each other. The term “adjacent” may include [but is not limited to] structures or components situated generally near or generally close to each other, which may or may not be touching and/or connected.

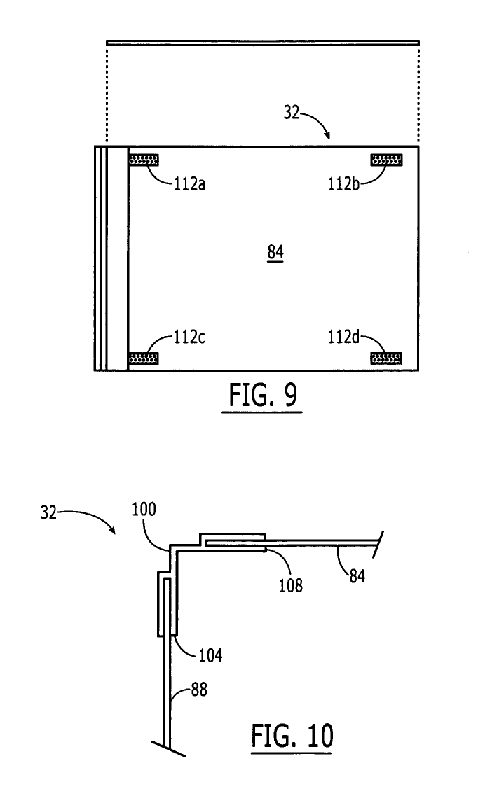

The first panel 84 and the second panel 88 may be positioned along a first edge 92 and a second edge 96 of the tray portion 28 of the P-Pole 20. A coupling 100 may be provided to seat the first panel 84 and the second panel 88. The term “coupling” may include [but is not limited to] one or more structures or components that join two things, including a device for connecting two things and/or objects. The illustrated coupling 100 includes a first seat 104 and a second seat 108. It will be appreciated from FIG. 9 and FIG. 10 that various suitable couplings may be employed. The coupling 100 may serve as a support for the first panel 84 and the second panel 88. The term “support” may be understood to include [but is not limited to] one or more structures or components adapted to generally hold up, serve as a foundation for, and/or a prop for something.

The absorbent material 36 is shown operatively connected to the pole portion 24 of the P-Pole 20. The term “absorbent” material may be understood to include [but is not limited to] any structure or material capable of soaking up, sucking up, or taking up liquid. A portion of the absorbent material 36 may be positioned generally vertically along the pole portion 24. A portion of the absorbent material 36 may be positioned generally vertically along the tubular extension 76. A portion of the absorbent material 36 may be positioned generally horizontally along the base portion 60.

The absorbent material 36 may be secured to the first panel 84 and the second panel 88 as desired. The first panel 84 is shown with fasteners 112a, 112b, 112c, 112d. The fasteners may be Velcro, adhesive, tape, or any other suitable fastener. The absorbent material 36 may be provided in pad(s). The term “pad” may be understood to include [but is not limited to] a generally thin and/or generally flat mat or cushion. The absorbent material 36 may be a dressing or protective covering—such as for example a diaper-type absorbing material.

In operation, the P-Pole 20 may be employed to allow for an animal, such as a dog or other pet, to urinate indoors. The P-Pole 20 may also work with the pet's defecation waste. Without the P-Pole 20, the dog would have to either urinate on the furniture or floor, or wait for the dog's owner to let the dog out of the residence to urinate. Having the pet urine on the furniture or floor is undesirable. Having the pet wait for extensive periods of time to urinate is generally inhumane and/or unsuccessful, even with training of the pet.

When the dog urinates, the urine collects onto the absorbent material and/or drips into the tray portion 28 of the P-Pole 20. When the dog lifts a leg to urinate and urinates on the pole portion 24 and/or the extension 76, the absorbent material on the pole portion 24 and/or the extension 76 preferably absorbs the urine. The soiled absorbent material can be removed and replaced with a fresh section of absorbent material. The urine that collects on the tray portion 28 can be easily cleaned and removed as well. The screen portion 32 of the P-Pole 20 allows for the dog to urinate without the urine splashing onto a nearby wall, floor, furniture or the like.

Alternate embodiments may be employed. The invention may be made from any suitable material and by any suitable method. The invention may be adapted to fit a wide variety of uses. It will be appreciated that the components of the invention may be easily modified as needed to accommodate varying sizes and shapes. For example, the pole portion 24 and/or the extension 76 can be any suitable height/width or adjustable in height/width. This may be desirable for pets of varying sizes. The absorbent material 36 could be covered with a screen [or the like] to keep the pet from tearing up or removing the absorbent material 36. The absorbent material 36 may be removeably connected to the pole portion 24. Training the pet on proper use of the invention will enhance effectiveness. Appropriate behavior modification techniques may assist the pet owner or pet handler in that responsibility and increase the likelihood of successful employment of the invention.

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A device for waste relief by an animal comprising:
a generally vertical pole portion;
a generally horizontal tray portion operatively connected to the pole portion;
a generally vertical screen portion operatively connected to the tray portion; and
an absorbent material operatively connected to the pole portion,
wherein a portion of the absorbent material is positioned generally vertically along the pole portion.

2. The device of claim 1 wherein the pole portion is generally conical.

3. The device of claim 2 wherein the pole portion includes an opening at the top of the pole portion.

4. The device of claim 1 further comprising a generally vertical generally tubular extension operatively connected to the pole portion.

5. The device of claim 4 further comprising a spacer positioned between the inner diameter of the tubular extension and the pole portion.

6. The device of claim 1 wherein the pole portion is positioned in a generally central region of the tray portion.

7. The device of claim 1 wherein the screen portion is positioned in a peripheral region of the tray portion.

8. The device of claim 7 wherein the screen portion is generally flat.

9. The device of claim 7 wherein the screen portion includes a first panel and a second panel.

10. The device of claim 9 wherein the first panel and the second panel are positioned generally perpendicular to each other.

11. A device for collecting animal waste comprising:
a generally vertical pole portion;
a generally horizontal tray portion operatively connected to the pole portion;
a generally vertical screen portion having a first panel positioned along a first edge of the tray portion and a second panel positioned along a second edge of the tray portion and being operatively connected to the tray portion; and
an absorbent material operatively connected to the pole portion,
wherein a portion of the absorbent material is positioned generally vertically along the pole portion and removeably connected to the pole portion.

12. The device of claim 11 wherein the pole portion is generally conical.

13. The device of claim 12 wherein the pole portion includes an opening at the top of the pole portion.

14. The device of claim 11 further comprising a generally vertical generally tubular extension operatively connected to the pole portion.

15. The device of claim 14 further comprising a spacer positioned between the inner diameter of the tubular extension and the pole portion.

16. The device of claim 11 wherein the pole portion is positioned in a generally central region of the tray portion.

17. The device of claim 11 wherein the screen portion includes a first panel and a second panel.

18. The device of claim 17 wherein the first panel and the second panel are positioned generally perpendicular to each other.

19. The device of claim 17 wherein the first panel and the second panel are generally flat.

20. The device of claim 11 wherein the absorbent material is a diaper material.
